(19) United States
(12) Patent Application Publication
(10) Pub. No.: US 2013/0233735 A1
(43) Pub. Date: Sep. 12, 2013

(54) Case for Holding Paintbrushes

(71) Applicants: James Steven Hurley, Niagara Falls, NY (US); Hirak Mitra, Santa Clara, CA (US); Donald Carson Lewis, Richmond, CA (US)

(72) Inventors: James Steven Hurley, Niagara Falls, NY (US); Hirak Mitra, Santa Clara, CA (US); Donald Carson Lewis, Richmond, CA (US)

(21) Appl. No.: 13/787,792

(22) Filed: Mar. 6, 2013

Related U.S. Application Data
(60) Provisional application No. 61/608,111, filed on Mar. 8, 2012.

(51) Int. Cl. B44D 3/12

(52) U.S. Cl. CPC B44D 3/125
USPC 206/209; 206/1.7

(57) ABSTRACT

A case that stores one or more paintbrushes in manner to prevent paint in them from drying out, so that there is no need to clean those brushes between uses; moreover the case containing a pump evacuator to remove air from the case when it is closed, thus further retarding the drying of the brushes inside; and finally the case holding paint drying retardant that evanesces into the atmosphere inside the case, further slowing down the drying of the brushes inside.

This patent application claims the priority of Provisional Patent Application 61/608,111.

### FIELD AND BACKGROUND

This pertains to the field of commercial and residential painting.

Currently in commercial and residential painting the painter must clean each paintbrush after each use. He must clean these paintbrushes thoroughly to remove all residual paint. Otherwise paint dries on the brush, after which the painter must either spend a lot of effort cleaning out dry paint, or throw the brush away. This is wasteful, since often at the end of a day the painter has to spend time and effort cleaning out his brush, only to apply the same paint to the same brush again the next day. This also wastes paint. And finally, in many places it is both illegal, and dangerous to the environment, to clean paint out of paintbrushes, since the effluent from this cleaning goes down the sewage system, or into the groundwater.

It would be better if after a use a painter could let a brush sit with paint in it, over a period of hours or days, and then start to use the brush again without cleaning it.

Also, currently some paints contain drying retardants which slow down their drying out. But these are integrated into the paints themselves. If a paint lacks such a retardant the painter must mix it into the paint, or go without it.

### PRIOR ART

The following prior art seems pertinent:

| US Patent | Issue Date | Patentee |
|---|---|---|
| 1,869,753 | Aug. 16, 1932 | Kamm |
| 1,934,316 | Sep. 07, 1933 | Loomis |
| 5,351,812 | Oct. 04, 1994 | Eagon |

U.S. Pat. Nos. 1,869,753 and 1,934,316 both present methods and devices to encapsulate only the heads of paintbrushes. But while these methods and devices will protect a brush head from mechanical damage due to contact with other objects, the method and device of U.S. Pat. No. 1,934,316 will not prevent the brush from drying out, while the method and device of U.S. Pat. No. 1,869,753 will need to fit specifically on a given paintbrush so that a single such device will not suffice to protect brushes which have different sized necks.

U.S. Pat. No. 3,531,812 presents a method and device to encapsulate a palette completely.

### SUMMARY

In an embodiment an airtight container holds paintbrushes so that they do not dry out. The paintbrush container holds the entire brush, not just the head. Also, the brush case has built into it an evacuator, which evacuates the atmosphere of the case, thus retarding the drying of the paint further. Finally the brush case itself holds a paint retardant chemical either in solid form which evanesces, or in liquid form which evaporates, into the atmosphere inside the case, thus retarding the drying process further.

### Advantages

There are several advantages of this approach over what painters currently do.

The painter does not waste time cleaning out his brush after each use.

The painter does not waste paint cleaning out his brush after each use.

Often the painter leaves his brush at a job site: If so, he typically cleans out his brush at the job site, washing paint (illegally) into the sewage system. If he does not need to clean out his paintbrushes at the job site he can take them back to his main work and storage space, and clean the paintbrushes legally and properly.

### Overview

In some embodiments the brush case holds a brush so that its bristles do not touch the sides or bottom of the case; by keeping a firm grip around the brush handle of any brush within it using foam pads.

In some embodiments the brush case holds a brush so that its bristles do not touch the sides or bottom of the case; by securing the handle of any brush within it with an elastic strap.

In some embodiments the brush case holds a brush so that its bristles do not touch the sides or bottom of the case; by hanging the handle of any brush with it from a hook inside the case.

In some embodiments the brush case holds just one brush, while in other embodiments the brush case holds more than one brush.

In some embodiments the brush case sits on a surface. In some embodiments the brush case hangs off of a hook. In some embodiments the brush case has a handle to carry it. In some embodiments the handle on the brush case is shaped so that it can hang off a hook.

### BRIEF DESCRIPTION OF DRAWINGS

FIG. 1 illustrates an exemplar of the first embodiment as seen open.

FIG. 2A illustrates an exemplar of the second embodiment as seen open.

FIG. 2B illustrates an exemplar of the second embodiment as seen ajar.

FIG. 2C illustrates an exemplar of the second embodiment as seen closed.

FIG. 3 illustrates an exemplar of the third embodiment as seen open.

FIG. 4 illustrates an exemplar of the fourth embodiment as seen open.

### DETAILED DESCRIPTION OF THE EMBODIMENTS

### First Embodiment

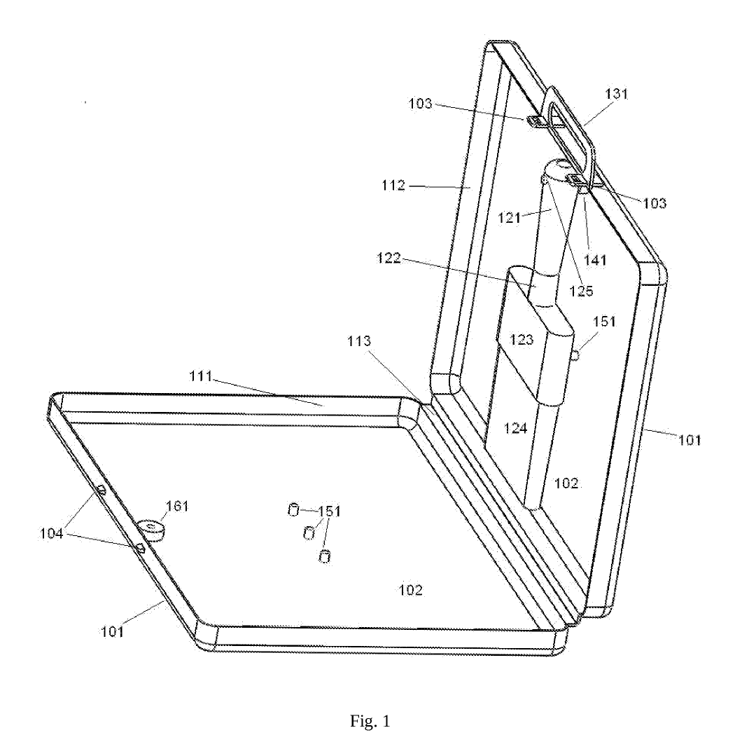

One embodiment [FIG. 1] is a case designed to hold one entire brush.

The case has an outer shell (101) made of metal. The outer shell is not itself airtight but the case has an airtight inner lining (102) made of rubber. The case splits apart into two halves (111, 112) which connect by a crease in the case (113). The two halves are locked shut together with clasps (103, 104).

One half (112) has a handle (131) by which one can carry the brush case.

The brush (121, 122, 123, 124) is caught between flexible rubber pegs (151) which trap its handle (123), thus preventing its bristles (124) from touching the case when the case is closed. The handle of the brush (121) has a hole in it. The brush case has a peg (141) which can go through this hole and thus hang the brush.

The case contains a liner (102) to catch any fluids coming off of the brush bristles (124). The liner is disposable. The liner may be impregnated with turpentine or some other chemical in solid form that evanesces, or liquid form that evaporates, into the atmosphere inside the brush case, which further inhibits the paint remaining in the brush from drying out.

The case may also contain a solid chemical capsule that evanesces into the air inside the brush case, which further inhibits the paint remaining in the brush from drying out.

When the case is closed is sits on a horizontal surface or hangs from its handle (105).

When the case is closed one uses the pump evacuator (161) to remove air from the case. Removing this air further slows the drying of the brush.

### Operation of the First Embodiment

To store a brush in the brush case one unlocks the clasps (103, 104) and pulls the two pieces of the brush case (111, 112) apart. Then one lays down the brush (121, 122, 123, 124) inside the case such that the peg in the brush case (141) goes through the hole in the brush handle (125). Then one closes the two pieces of the brush case back together, locking them shut with the clasps (103, 104).

To remove the brush from the brush case one unlocks the clasps, opens the case, removes the brush and then closes the case and locks the clasps again.

When the brush is in the case and the case is closed one pushes the pump evacuator (161) repeatedly to evacuate the air in the brush case, thus slowing the rate at which the brush dries even further.

### Alternatives For the First Embodiment

Here are some alternatives for the first embodiment shown in [FIG. 1].

In some embodiments the outer shell (101) is made of metal. In some embodiments the other shell is made of plastic. In some embodiments the outer shell is made of rubber. In some embodiments the outer shell is made of some other resilient elastomer. In some embodiments the outer shell is made of some other material.

In some embodiments the outer case (101) is itself airtight and there is no inner lining. In some embodiments the inner lining is made of rubber. In some embodiments this lining is made of polyethylene. In some embodiments this lining is made of some other airtight resilient elastomer.

In some embodiments the outer case opens into two halves (111, 112) that are equal in size. In some other embodiments the two halves are not equal in size.

In some embodiments the pieces of the outer case lock shut using clasps. In some embodiments the pieces of the outer case lock shut using adhering straps. In some embodiments the pieces of the outer case lock shut by some other means.

In some embodiments the top half (112) has a handle (131) by which to hold the brush case, but the bottom half (111) does not. In other embodiments the bottom half has a handle but the top half does not. In other embodiments both halves have pieces of a handle which fit together when the case is closed, to form one handle. In other embodiments the handle is absent.

In some embodiments the brush case has a peg by which to hang the brush. In some other embodiments the brush case has a hook by which to hang the brush. In some other embodiments the brush case has some other means such as straps or pads to hold the brush in place inside the case.

In some embodiments the liner (102) fits snugly inside the case but is not attached to the case. In some other embodiments the liner attaches to the case by some means. In some embodiments the liner is disposable. In some embodiments the liner is reusable. In some other embodiments the liner is absent. In some other embodiments it is optional to use the liner.

In some embodiments the liner is not impregnated. In some other embodiments the liner is impregnated with a chemical. In some other embodiments whether the liner is impregnated with a chemical is decided by the person using the case. In some embodiments the chemical impregnating the liner is water. In some other embodiments the chemical is turpentine. In some other embodiments the chemical is some other ant-drying agent.

In some embodiments the pump evacuator (161) is present. In other embodiments it is absent.

### Second Embodiment

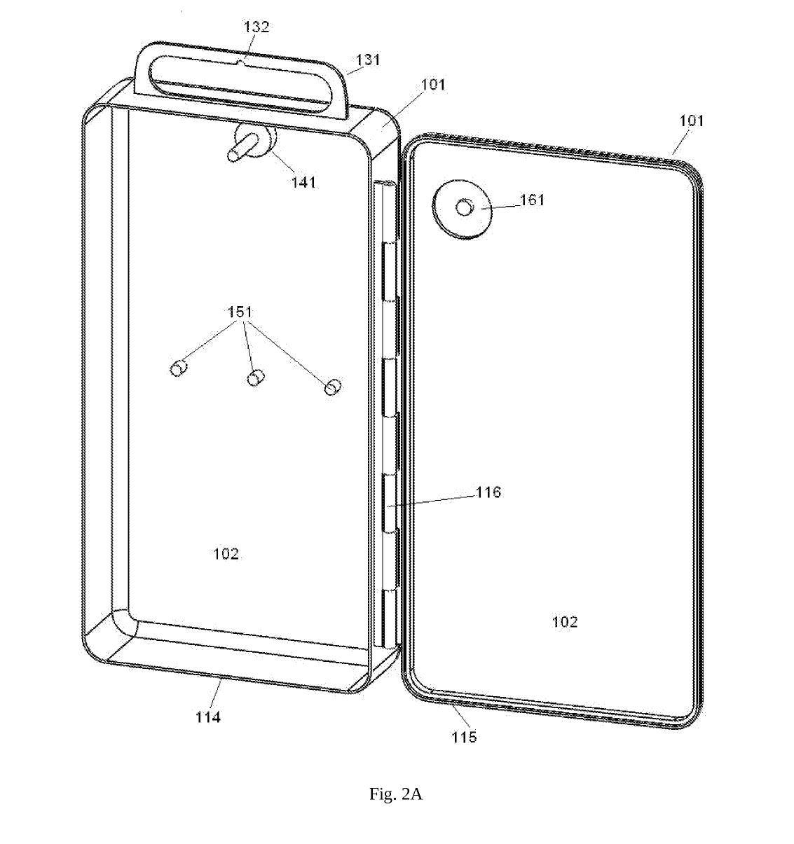

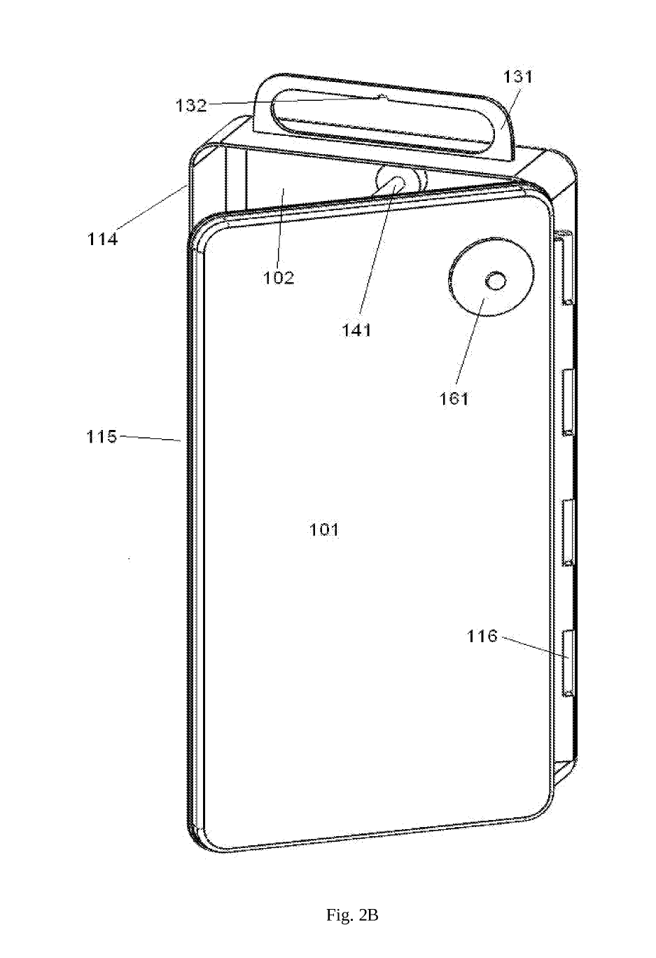

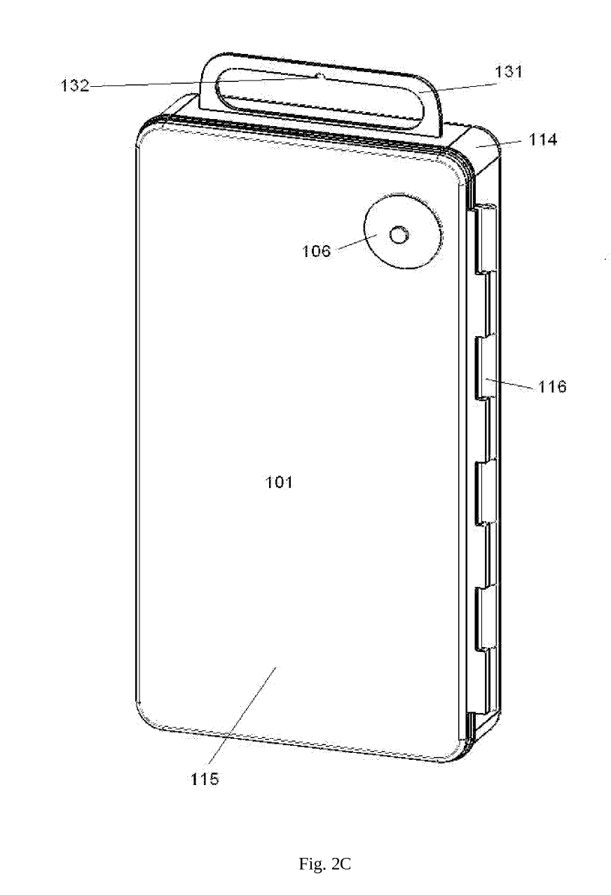

One embodiment [FIGS. 2A, 2B, 2C] is a case (101) designed to hold an entire brush. As with the first embodiment the brush has a hole in its handle and from this hole hangs inside the case off of a peg (141, 142) mounted onto the inside of the case.

The case is rectilinear. It has a door (115) which separates from the main body of the case (114). The body and door attach to each other with hinges (116). There are no locking clasps, the door and body simply fit snugly over one another. To store the brush the user opens this door and hangs the brush off the peg and shuts the door again. To retrieve a stored brush the user opens the door and takes the brush out.

As in the first embodiment the brush is caught between flexible rubber pegs (151) which trap its handle, thus preventing its bristles from touching the case when the case is closed. The handle of the brush has a hole in it. The brush case has a peg (141) which can go through this hole and thus hang the brush.

The case is designed to sit on a flat surface.

The case has a handle (131) by which the user can pick up the case, and this handle has a dimple (132) by which the user can hang the case from a hook or some other implement.

When the case is closed one uses the pump evacuator (161) to remove air from the case. Removing this air further slows the drying of the brush.

### Operation of the Second Embodiment

To store a brush in the brush case one pulls the door of the brush case (115) apart from the body (114). Then one hangs down the brush from the peg (141) going through the hole in the brush handle. Then one closes the two pieces of the brush case back together, locking them shut with the clasps.

To remove the brush from the brush case one unlocks the clasps, opens the case, removes the brush and then closes the case and locks the clasps again.

When the brush is in the case and the case is closed one pushes the pump evacuator (161) repeatedly to evacuate the air in the brush case, thus slowing the rate at which the brush dries even further.

### Alternatives For the Second Embodiment

Here are some alternatives for the second embodiment shown in [FIG. 2]. In some embodiments the shape of the case is cylindrical. In some other embodiments the shape is tapered and shaped like a brush. In some other embodiments the case is of some other topological shape that encloses the brush.

In some embodiments the door (115) attaches to the case body (114) with two hinges (116). In other embodiments it attaches with just one hinge. In other embodiments it attaches with some other plurality of hinges.

In some embodiments the door locks to the case with one locking clasp. In other embodiments the door locks to the case with two locking clasps. In other embodiments to door locks to the case with some other plurality of locking clasps. In other embodiments the door locks to the case with one elastic band. In other embodiments the door locks to the case with two elastic bands. In other embodiments the door locks to the case with some other plurality of elastic bands. In other embodiments the door locks to the case by some other means.

In some embodiments the handle (131) has a “dimple”, a shaped indentation (132) by which the user can hang the case from a hook or some other implement. In some other embodiments the handle has a plurality of dimples. In other embodiments the handle has no dimples.

In some embodiments the brush case has a peg by which to hang the brush. In some other embodiments the brush case has a hook by which to hang the brush. In some other embodiments the brush case has some other means such as straps or pads to hold the brush in place inside the case.

In some embodiments the liner (102) fits snugly inside the case but is not attached to the case. In some other embodiments the liner attaches to the case by some means. In some embodiments the liner is disposable. In some embodiments the liner is reusable. In some other embodiments the liner is absent. In some other embodiments it is optional to use the liner.

In some embodiments the pump evacuator (161) is present. In other embodiments it is absent.

### Third Embodiment

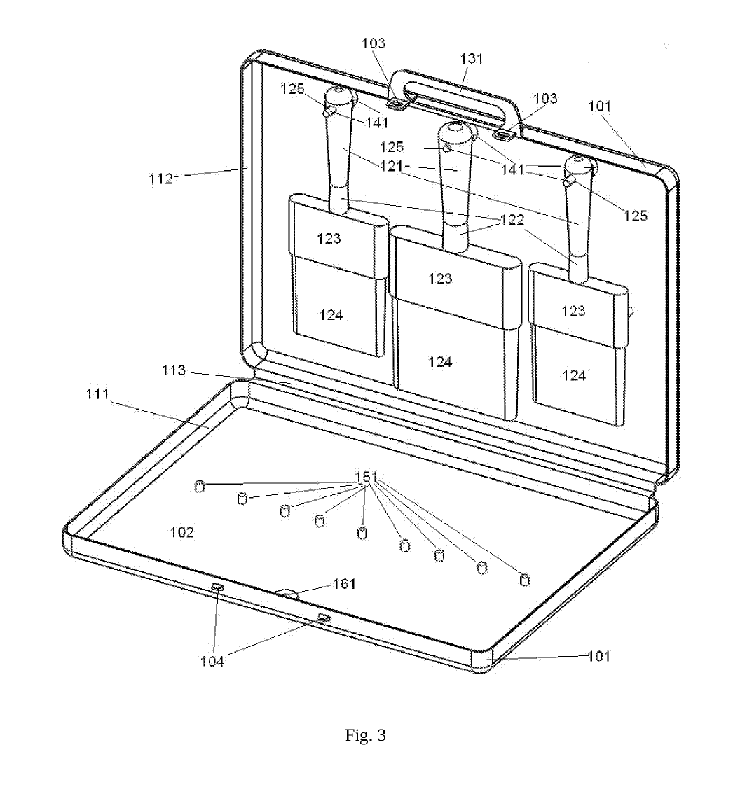

One embodiment [FIG. 3] is a case (101) designed to hold a plurality of brushes (121, 122, 123, 124).The case has a plurality of pegs (141) that hold the brushes by the holes in their handles (125) so that they do not slip inside the case.

The case has a handle (131) by which the user can pick up the case, and this handle has a dimple (132) by which the user can hang the case from a hook or some other implement.

The case contains a liner (107) to catch any fluids coming off of the brush bristles (124).

The case has push-button evacuator (161) which, when the case is closed, may be used to evacuate the atmosphere inside the case, further slowing the drying of the brushes.

In all other particulars this embodiment is similar to the first embodiment.

### Operation of the Third Embodiment

To store a plurality of brushes in the brush case one unlocks the clasps (103, 104) and pulls the two pieces of the brush case (111, 112) apart. Then one lays down the brush (121, 122, 123, 124) inside the case such that the peg in the brush case (141) goes through the hole in the brush handle (125). Then one closes the two pieces of the brush case back together, locking them shut with the clasps (103, 104).

To remove the brush from the brush case one unlocks the clasps, opens the case, removes the brush and then closes the case and locks the clasps again.

When the brush is in the case and the case is closed one pushes the pump evacuator (161) repeatedly to evacuate the air in the brush case, thus slowing the rate at which the brush dries even further.

### Alternatives For the Third Embodiment

Here are some alternatives for the third embodiment shown in [FIG. 3].

In some embodiments the brush case is designed to hold two brushes. In some other embodiments the brush case is designed to hold three brushes. In some other embodiments the brush case is designed to hold four brushes. In some other embodiments the brush case is designed to hold some other number of brushes.

In some embodiments the outer shell (101) is made of metal. In some embodiments the other shell is made of plastic. In some embodiments the outer shell is made of rubber. In some embodiments the outer shell is made of some other material.

In some embodiments the outer case (101) is itself airtight and there is no inner lining. In some embodiments the inner lining is made of rubber. In some embodiments this lining is made of polyethylene. In some embodiments this lining is made of some other airtight material.

In some embodiments the outer case opens into two halves (111, 112) that are equal in size. In some other embodiments the two halves are not equal in size.

In some embodiments the pieces of the outer case lock shut using clasps. In some embodiments the pieces of the outer case lock shut using adhering straps. In some embodiments the pieces of the outer case lock shut by some other means.

In some embodiments the top half (112) has a handle (131) by which to hold the brush case, but the bottom half (111) does not. In other embodiments the bottom half has a handle but the top half does not. In other embodiments both halves have pieces of a handle which fit together when the case is closed, to form one handle. In other embodiments the handle is absent.

In some embodiments the brush case has a peg by which to hang the brush. In some other embodiments the brush case has a hook by which to hang the brush. In some other embodiments the brush case has some other means such as straps or pads to hold the brush in place inside the case.

In some embodiments the liner (102) fits snugly inside the case but is not attached to the case. In some other embodiments the liner attaches to the case by some means. In some embodiments the liner is disposable. In some embodiments the liner is reusable. In some other embodiments the liner is absent. In some other embodiments it is optional to use the liner.

In some embodiments the pump evacuator (161) is present. In other embodiments it is absent.

### Fourth Embodiment

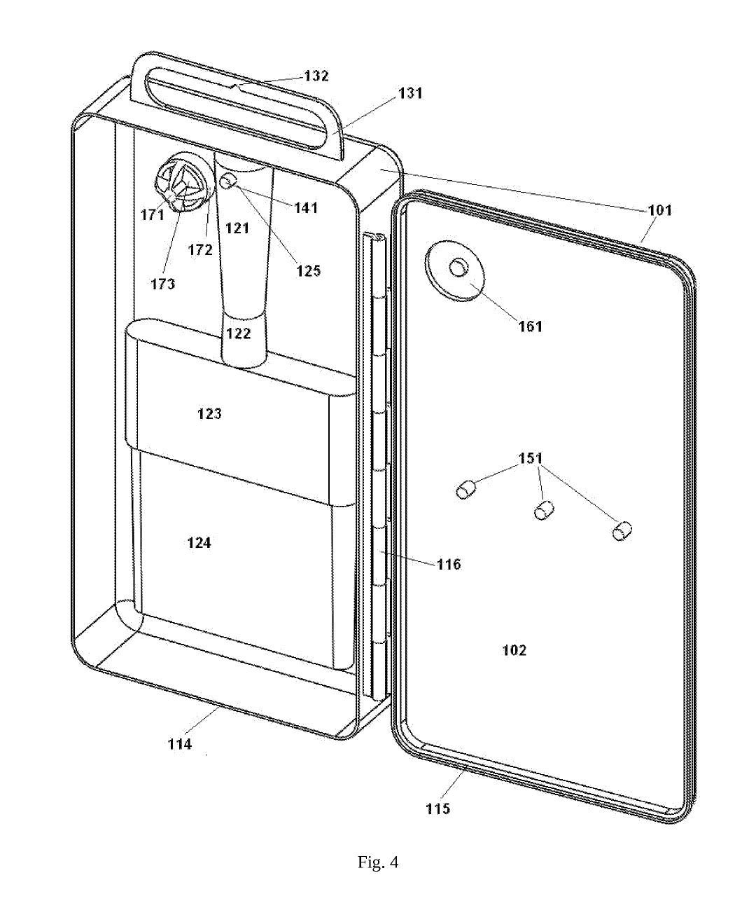

Any embodiment may also use a chemical agent to retard further the drying of the paint in the paintbrushes. One embodiment [FIG. 4] shows this.

In the following regards this embodiment is similar to the second embodiment presented above:

This embodiment is a case (101) designed to hold an entire brush.

As with the first embodiment the brush has a hole in its handle and from this hole hangs inside the case off of a peg (141, 142) mounted onto the inside of the case.

The case is rectilinear. It has a door (115) which separates from the main body of the case (114). The body and door attach to each other with hinges (116). There are no locking clasps, the door and body simply fit snugly over one another. To store the brush the user opens this door and hangs the brush off the peg and shuts the door again. To retrieve a stored brush the user opens the door and takes the brush out.

As in the first embodiment the brush is caught between flexible rubber pegs (151) which trap its handle, thus preventing its bristles from touching the case when the case is closed. The handle of the brush has a hole in it. The brush case has a peg (141) which can go through this hole and thus hang the brush.

The case is designed to sit on a flat surface.

The case has a handle (131) by which the user can pick up the case, and this handle has a “dimple”, a shaped indentation (132) by which the user can hang the case from a hook or some other implement.

When the case is closed one uses the pump evacuator (161) to remove air from the case. Removing this air further slows the drying of the brush.

In the following regards this embodiment is different from the second embodiment presented above:

The case has a pill holder (171, 172) comprising a base (172) and a piece (171) that screws into it to hold a chemical pill (173) in place. The piece that attaches has apertures to allow the pill to evanesce into the atmosphere of the container.

### Operation of the Fourth Embodiment

To store a brush in the brush case one pulls the door of the brush case (115) apart from the body (114). Then one hangs down the brush from the peg (141) going through the hole in the brush handle. Then one closes the two pieces of the brush case back together, locking them shut with the clasps.

To remove the brush from the brush case one unlocks the clasps, opens the case, removes the brush and then closes the case and locks the clasps again.

When the brush is in the case and the case is closed one pushes the pump evacuator (161) repeatedly to evacuate the air in the brush case, thus slowing the rate at which the brush dries even further.

One can further retard paint drying inside of the case by placing a tablet of turpentine in the pill holder. This tablet evaporates into the atmosphere inside the closed case, retarding the paint drying.

### Alternatives For the Fourth Embodiment

The fourth embodiment [FIG. 4] is identical to the second embodiment except that the fourth embodiment has a pill case inside the brush case, and this pill case holds chemical pill that evanesces into the atmosphere inside the brush case.

In some embodiments the shape of the pill case is circular. In some other embodiments it is square. In some other embodiments it is some other geometric shape.

In some embodiments the top of the pill case screws onto the base of the pill case. In some other embodiments the top of the pill case snaps onto the base of the pill case. In some other embodiments the top of the pill case locks onto the base of the pill case by some other mechanism.

In some embodiments there is one pill case. In other embodiments there is no pill case, and a pill may lie at the bottom of the case where it evanesces away. In yet other embodiments there are a plurality of pill cases.

In some embodiments the chemical pill is turpentine. In other embodiments it is some other chemical agent to retard the drying of paint.

In some embodiments which have more than one pill case, these pill cases hold more than one kind of chemical pill.

### Conclusions, Ramifications And Scope

All said, the various embodiments described here will be a boon to painters, freeing them from having to clean their brushes and waste paint. Also it will enable the painter to become more environmentally responsible, since it will free him from the need to wash his paintbrushes illegally at job sites.

We claim:

1. An airtight case with the new usage of containing a plurality of paintbrushes for the purpose of keeping said paintbrushes from drying out.

2. The case of claim 1 having evacuator pump that removes air from said case in order to slow drying of said paintbrushes further.

3. The case of claim 1 containing a plurality of pegs whereby to hang said paintbrushes inside the case so that the bristles of said paintbrushes do not touch other paintbrushes or the bottom of said case.

4. The case of claim 1 containing a plurality of elastic nubs to hold said paintbrushes in place in such a way that the bristles of said paintbrushes do not touch other paintbrushes or the bottom of the case.

5. The case of claim 1 having a handle with a notch cut in it, whereby if one hangs said handle from a hook then said hook falls into said notch.

6. The case of claim 1 containing a liner to capture fluids falling from said paintbrushes, without touching said paintbrushes.

7. The liner of claim 7 being disposable.

8. The liner of claim 7 being washable.

9. The liner of claim 7 being impregnated with a plurality of chemical agents which evaporate or evanesce into the atmosphere inside the brush case which has the effect of further retarding said paint from drying out.

10. The case of claim 1 containing a plurality of capsules placed inside it, where each of said capsules comprises a plurality of chemical agents in solid or liquid form which evanesce or evaporate into the atmosphere inside the brush case, resulting in further retarding said paint from drying out.

11. The capsules of claim 10 being held in a plurality of containers, such that each container is integrated into the body of said case, whereby said capsules are held in place inside the case; thereby enabling said capsules to evanesce properly.
